(19) United States
(12) Patent Application Publication
(10) Pub. No.: US 2008/0043382 A1
(43) Pub. Date: Feb. 21, 2008

(54) COMPLEX SUPERCONDUCTING FAULT CURRENT LIMITER

(75) Inventors: Bang-Wook LEE, Cheongju (KR); Kwon-Bae PARK, Daejeon (KR)

Correspondence Address: GREENBLUM & BERNSTEIN, P.L.C., 1950 ROLAND CLARKE PLACE, RESTON, VA, 20191, US

(73) Assignee: LS INDUSTRIAL SYSTEMS CO., LTD., Seoul (KR)

(21) Appl. No.: 11/616,458

(22) Filed: Dec. 27, 2006

(30) Foreign Application Priority Data
Aug. 17, 2006 (KR) 10-2006-0077520

(51) Int. Cl. H02H 7/00

(52) U.S. Cl. 361/19

(57) ABSTRACT

The present invention relates to a complex superconducting fault current limiter which adds a current limiting reactor to a superconductor to protect the power line from a fault current, and more particularly, to a complex superconducting fault current limiter using a minimum number of superconducting fault current limiters, while avoiding series and parallel connections of a plurality of superconductors and coils, in order to economically manufacture the fault current limiter in a small size. A superconductor, a high speed switch, and a circuit breaker are connected in series to each other, and a first reactor with a low impedance and a second reactor with a high impedance are connected in parallel to the power line so as to provide a branch circuit for the current to the series circuit. A semiconductor switch is connected in parallel to the second reactor with a high impedance in accordance with the opening high speed switch. A circuit is breaker trip drive controller is configured so as to be connected to the superconductor and the branch circuit, and when a fault current occurs, the fault current is branched into the branch circuit, so that the second reactor limits the fault current. When a fault current occurs, the circuit breaker trip drive controller provides a trip drive signal to the circuit breaker for tripping in accordance with the voltage of the superconductor or the current of the branch circuit.

### RELATED APPLICATION

The present disclosure relates to subject matter contained in priority Korean Application No. 10-2006-0077520, filed on Aug. 17, 2006, which is herein expressly incorporated by reference in its entirety.

### BACKGROUND OF THE INVENTION

1. Field of the Invention

The present invention relates to a superconducting fault current limiter that can effectively limit a fault current that occurs on an electric power system by using a superconductor, and more particularly, to a complex superconducting fault current limiter capable of minimizing the time for the superconductor to bear a large current and high voltage when a fault current occurs, by reciprocally and systematically connecting a high speed switch, a semiconductor switch and a reactor in the superconductor, in order to economically manufacture the fault current limiter in a small size.

2. Description of the Background Art

A superconductor rarely resists against the current flowing on the power line until the current reaches a predetermined threshold current, but the resistance rises sharply when the current surpasses the threshold current. Because of such characteristics, a superconductor may function as a fault current limiting element which limits a fault current in a electric power system, such as a short circuit current.

Conventionally, a superconducting fault current limiter had used liquid helium as a refrigerant to keep a superconducting state, but problems such as a significant refrigerating cost and a complicated manufacture deterred worldwide studies on the superconducting fault current limiter. However, as a superconductive material using liquid nitrogen to keep a superconducting state has been recently developed, studies on a superconducting fault current limiter using the material are gaining momentum.

Superconducting fault current limiters using superconductors are classified into a resistive fault current limiter, an inductive fault current limiter, and a complex fault current limiter or the like. Since such superconducting fault current limiters are required to bear a high voltage and large current in an electric power system, the superconducting fault current limiters should use an exponentially large amount of superconductors. In other words, to have a bearable force of the superconducting fault current limiter against a high voltage, a large number of superconductors should be connected in series, and to have an bearable force against a large current, a large number of superconductors should also be connected in parallel.

The above-mentioned conventional art will be described hereafter with reference to FIG. 1.

The superconducting fault current limiter according to the conventional art, shown in FIG. 1, comprises a current limiting matrix 220, and a trigger matrix 218 that provides magnetic fields to allow simultaneous quenching (transition from a superconducting state to a normally conductive state, that is resistive state) of superconductors in the current limiting matrix 220. To be more specific, the current limiting matrix 220 is formed by connecting m-current limiting modules (312-1\dot{˜}312-m) in series, the current limiting module is formed by connecting n-current limiting matrix elements (314-1˜314n) in parallel. Here, each of the current limiting matrix elements (314-1˜314n) comprises one superconductor.

The trigger matrix 218 is formed by connecting the n-trigger matrix elements (310-1˜310-n) in parallel, each of the trigger matrix elements (310-1˜310-n) comprises one superconductor and is connected to the n-current limiting matrix elements (314-1˜314n), respectively.

In FIG. 1, reference numerals A and C each indicate an input terminal and an output terminal of the superconducting fault current limiter according to the conventional art.

The superconducting current limiting modules are configured by modifying the number of series and parallel connections in accordance with the electric power system where the superconducting fault current limiter is used, that is, the capacity of voltages and currents of power lines (circuits).

The above-mentioned superconducting fault current limiter according to the conventional art has problems as follows.

First, series and parallel connections of a large number of superconductors are required to improve the bearable force of the superconducting fault current limiter against a high voltage and large current, and a container is accordingly required to contain refrigerant for keeping a superconducting state of the superconductor, which leads to a large size and huge manufacturing cost.

Second, while a large number of the superconductors are connected in series and parallel as described above, the superconductors should simultaneously quench in order to bear high temperature. Therefore, when manufacturing defects and poor performance are found in the process of manufacturing or of operating the superconductor, the superconductor is damaged thus likely causing malfunction to the superconducting fault current limiter. In other words, a partial malfunction of the superconductor may seriously affect the entire operation of the superconducting fault current limiter, which may leads to an unstable reliability.

### SUMMARY OF THE INVENTION

Therefore, an objection of the present invention is to provide a superconducting fault current limiter using a minimum number of superconductors, in order to economically manufacture the limiter in a small size, and ensure a reliable operation.

To achieve these and other advantages and in accordance with the purpose of the present invention, as embodied and broadly described herein, there is provided a complex superconducting fault current limiter comprises: a superconductor which is connected in series to the power line; a first switch which is connected in series to the superconductor, is closed to allow the current to flow on the power line when a normal current flows on the power line, and opened, when a large current flows on the power line, to break the power line, and opened by a magnetic force; a first reactor which has a first impedance that is smaller than an impedance of the superconductor when a larger current flows on the power line, is connected in parallel to the superconductor, and serves as a branch path for the current flowing through the superconductor and the first switch when a larger current flows on the power line, the first reactor being magnetized by the current flowing through the branch path thus to switch the first switch to be opened; a second reactor which is connected in series to the branch path formed by the first reactor, and has a second impedance that is larger than the first impedance of the first reactor so as to limit the large current; a semiconductor switch which is connected in parallel to the second reactor and capable of turning on by a trigger signal; and a trigger controller which stops sending the trigger signal to the semiconductor switch in response to the opening of the first switch.

Preferably, the complex superconducting fault current limiter of the present invention further comprises: a circuit breaker which breaks the power line when a large current flows on the power line, and is connected to the power line behind the superconductor, the first switch and the branch path, a current transformer which is connected to the branch path so as to detect the current flowing through the branch path, and outputs a first voltage signal corresponding to the detected current; and a circuit breaker trip drive controller which comprises a first input that is connected to the superconductor and to which a second voltage signal corresponding to the voltage of the superconductor is input, and a second input to which a first voltage signal from the current transformer is input, and provides a trip drive signal to the circuit breaker when either the first voltage signal or the second voltage signal is input.

Further, preferably, the trigger controller comprises an optical switch which has a light emitting part that emits an optical signal, and a light receiving part that provides the trigger signal to the semiconductor switch if the light receiving part receives an optical signal from the light emitting part when the first switch is closed, and which stops providing an optical signal to the semiconductor switch when the first switch is opened thereby cutting the optical signal.

Further, preferably, the trigger controller comprises a micro switch that is disposed on the way of opening position moving of the first switch so as to be interlocked to the position of the first switch, provides the trigger signal to the semiconductor switch when the first switch is closed, and when the first switch is opened, stops sending the trigger signal to the semiconductor switch.

In addition, preferably, the semiconductor switch comprises any one of a Thyristor, a TRIAC, an IGBT (Insulated Gate Bipolar Transistor), a GTO Thyristor (Gate Turn-off Thyristor), an SSR (Solid State Relay), an FET (Field Effect Transistor), and a Transistor.

In addition, preferably, the circuit breaker trip drive controller comprises an OR circuit which provides a trip drive signal to the circuit breaker, when either the first voltage signal or second voltage signal is input.

In addition, preferably, the circuit breaker trip drive controller comprises: a first comparator which compares the first voltage signal with a predetermined first reference voltage, and outputs a corresponding signal if the first voltage signal is larger than the first reference voltage; a second comparator which compares the second voltage signal with a predetermined second reference voltage, and outputs a corresponding signal if the second voltage signal is larger than the second reference voltage; and an OR circuit which is connected to the output of the first and second comparators, and outputs a trip drive signal to the circuit breaker if the signal is input to the OR circuit from at least one of the first and second comparators.

Preferably, the first switch is a normal close contact.

Further, preferably, the first switch comprises a stationary contact which is connected in series to the power line between the superconductor and the circuit breaker and the movable contact which can switch between a position in contact with the stationary contact to allow the current to flow on the power line and a position separated from the stationary contact by a magnetic force from the first reactor to break the power line.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating the configuration of a superconducting fault current limiter according to a conventional art;

FIG. 2 is a block diagram illustrating the configuration of a complex superconducting fault current limiter according to a first embodiment of the present invention;

FIG. 3 is a block diagram illustrating the configuration of a complex superconducting fault current limiter according to a second embodiment of the present invention;

FIGS. 4A and 48 are block diagrams illustrating the configuration of a circuit breaker trip drive controller in the complex superconducting fault current limiter of the present invention;

FIG. 4A is a block diagram illustrating the configuration of the circuit breaker trip drive controller according to the first embodiment;

FIG. 4B is a block diagram illustrating the configuration of the circuit breaker trip drive controller according to the second embodiment;

FIG. 5 is a wave form illustrating changes of current flowing through the superconducting fault current limiter of the present invention when a fault current occurs;

FIGS. 6 to 8 are explanatory views illustrating the operation of the complex superconducting fault current limiter of the present invention;

FIG. 6 is an explanatory view illustrating the operation when a normal current flows through the complex superconducting fault current limiter of the present invention;

FIG. 7 is an explanatory view illustrating the operation during the initial rise of a fault current flowing on the complex superconducting fault current limiter of the present invention; and

FIG. 8 is an explanatory view illustrating an operation completed state when a fault current flows through a branch circuit of the complex superconducting fault current limiter of the present invention.

### DETAILED DESCRIPTION OF THE INVENTION

Reference will now be made in detail to the preferred embodiments of the present invention, examples of which are illustrated in the accompanying drawings.

Hereinafter, preferred embodiments of the present invention will be described with reference to the accompanying drawings.

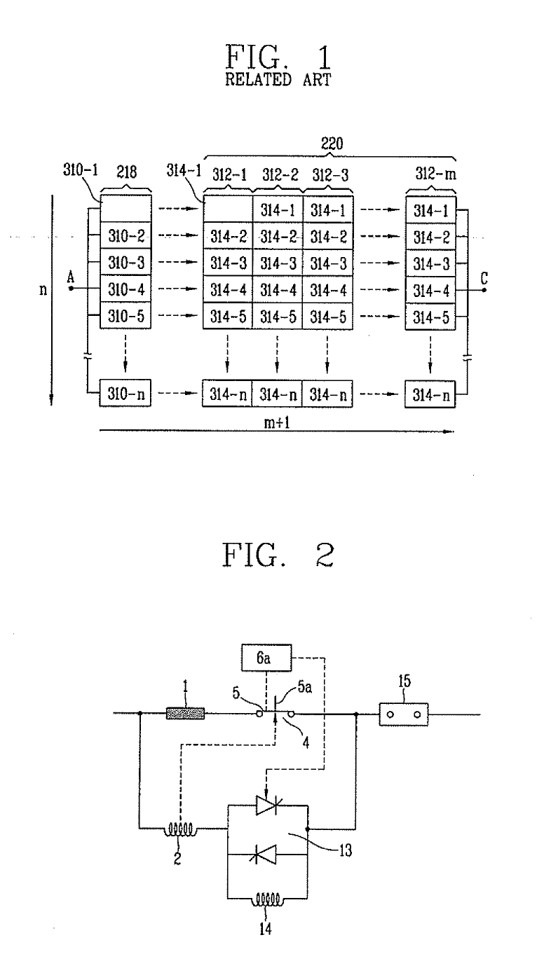

First, a complex superconducting fault current limiter according to a first embodiment of the present invention will be described with reference to a block diagram of configuration of FIG. 2.

The complex superconducting fault current limiter according to the first embodiment of the present invention comprises a superconductor 1 that is connected in series to the power line. The fault current limiter of the present invention comprises a first switch 4 which is connected in series to the superconductor 1. The switch is closed to allow the current to flow on the power line when a normal current flows on the power line, and opened when a large current flows on the power line, to break the power line. The switch can be opened by a magnetic force.

The fault current limiter comprises a first reactor 2 which has a first impedance that is smaller than an impedance of the superconductor 1 when a larger current flows on the power line, and is connected in parallel to the superconductor 1. In addition, when a larger current flows on the power line, the first reactor 2 serves as a branch path for the current flowing through the superconductor 1 and the first switch 4, and is magnetized by the current flowing through the branch path thus to switch the first switch 4 to be opened.

The fault current limiter of the present invention comprises a second reactor 14 which is connected in series to the branch path formed by the first reactor 2, and has a second impedance that is larger than the first impedance of the first reactor 2 so as to limit the large current.

The fault current limiter of the present invention comprises a semiconductor switch 13 which is connected in parallel to the second reactor 14 and turned on by a trigger signal.

The fault current limiter of the present invention comprises a trigger controller 6a which stops sending a trigger signal to the semiconductor switch 13 in response to the opening of the first switch 4.

The complex superconducting fault current limiter according to the present invention may further include a circuit breaker 15 which breaks the power line when a large current flows on the power line, the circuit breaker 15 is connected to the power line behind the superconductor 1, the first switch 4 and the branch path.

The first switch 4 may be formed of a normal close contact switch which can be switched to open by a magnetic force from the first reactor 2. In other words, when the first reactor 2 applies a magnetic force to the first switch 4, the first switch is opened. On the other hand, when the first reactor 2 does not apply a magnetic force to the first switch, the first switch is closed.

The first switch 4 comprises a stationary contact (not designated by reference numeral) that is connected in series to the power line between the superconductor 1 and the circuit breaker 15, and a movable contact 5 which can switch between a position in contact with the stationary contact to allow the current to flow and a position separated from the stationary contact by a magnetic force from the first reactor 2 to break the power line. A reference numeral 5a is a component which sends a displacement state of the opening of the first switch 4 to a trigger controller 6a that is included in the movable contact 5.

With this configuration, the first switch 4 functions as a high speed switch that can be opened and separated from the stationary contact within 1 ms (1 milli second).

The trigger controller 6a comprises an optical switch having a light emitting part which emits an optical signal, and a light receiving part which provides the trigger signal to the semiconductor switch 13 if the light receiving part receives an optical signal from the light emitting part when the first switch 4 is closed, and which stops providing the trigger signal to the semiconductor switch 13 when the first switch is opened thereby cutting the optical signal.

In addition, the trigger controller 6a comprises a micro switch that is disposed on the way of opening position moving of the first switch 4 so as to be interlocked to the position of the first switch 4, provides the trigger signal to the semiconductor switch when the first switch is closed and stops providing the trigger signal to the semiconductor switch 13 when the first switch is opened. The micro switch provides the trigger signal to the semiconductor switch 13 when the first switch 4 is closed, and the micro switch stops sending the trigger signal to the semiconductor switch 13 when the first switch 4 is opened.

The semiconductor switch 13 may be any one of a Thyristor, a TRIAC, an IGBT (Insulated Gate Bipolar Transistor), a GTO Thyristor (Gate Turn-off Thyristor), an SSR (Solid State Relay), an FET (Field Effect Transistor), and a Transistor.

The circuit breaker 15 may be formed of a well known circuit breaker for wiring or an air circuit breaker if the power line is a line for a relatively low voltage, otherwise, the circuit breaker may be formed of a well known vacuum circuit breaker if the power line is a line for a high voltage.

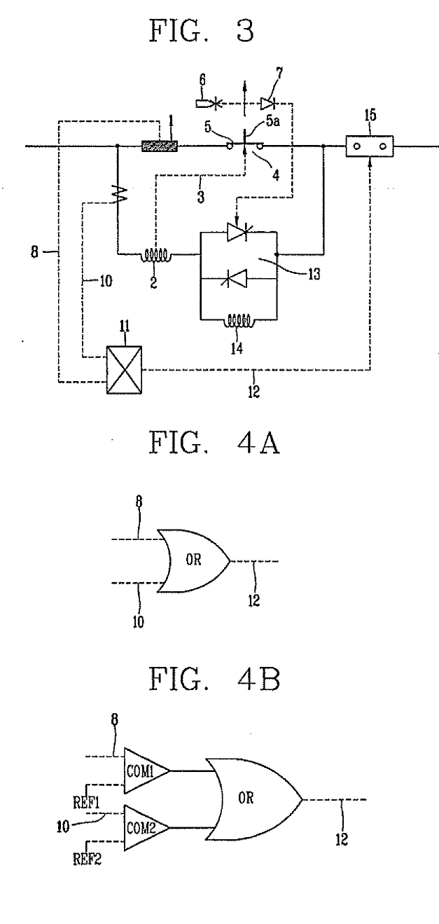

In the meantime, configuration of a complex superconducting fault current limiter according to a second embodiment of the present invention will be described with reference to FIG. 3.

The complex superconducting fault current limiter according to the second embodiment of the present invention comprises the superconductor 1 which is connected in series to the power line.

The fault current limiter according to the second embodiment of the present invention comprises the first switch 4 which is connected in series to the superconductor 1. When a normal current flows on the power line, the first switch 4 is closed to allow the current to flow on the power line, and when a large current flows on the power line, the first switch 4 is switched to open so as to break the current flowing on the power line. The first switch 4 can be switched to open by a magnetic force.

The fault current limiter according to the second embodiment of the present invention comprises the first reactor 2 which has a first impedance that is smaller than the impedance of the superconductor 1 when a large current flows on the power line, and is connected in parallel to the superconductor 1. In addition, the first reactor 2 serves as a branch path for the current flowing through the superconductor 1 and the first switch 4 when a large current flows on the power line, and is magnetized by the branch current flowing through the branch path thus to switch the first switch 4 to open.

The fault current limiter according to the second embodiment of the present invention comprises the second reactor 14 which is connected in series to the branch path that is formed by the first reactor 2 and has a second impedance larger than the first impedance of the first reactor 2 so as to limit the large current.

The fault current limiter according to the second embodiment of the present invention comprises the semiconductor switch 13 which is connected in parallel to the second reactor 14 and can be turned on by a trigger signal.

The fault current limiter according to the second embodiment of the present invention comprises trigger controllers 6 and 7 which stop sending the trigger signal to the semiconductor switch 13 in response to the opening of the first switch 4.

The fault current limiter according to the second embodiment of the present invention comprises the circuit breaker 15 which is connected to the power line behind the superconductor 1, the first switch 4 and the branch path and breaks the power line when a larger current flows on the power line.

The fault current limiter according to the second embodiment of the present invention comprises a current transformer (not designated by reference numeral) which is connected to the branch path so as to detect the current flowing through the branch path, and outputs a first voltage signal corresponding to the detected current.

The fault current limiter according to the second embodiment of the present invention comprises a circuit breaker trip drive controller 11 that comprises a first input 8 which is connected to the superconductor 1 and to which a second voltage signal corresponding to the voltage of the superconductor 1 is input, and a second input 10 to which a first voltage signal from the current transformer is input. The circuit breaker trip drive controller provides a trip drive signal to the circuit breaker 15 when either the first voltage signal or the second voltage signal is input.

The second embodiment of the present invention is different from the first embodiment of the present invention in that the fault current limiter further comprises the current transformer and the circuit breaker trip drive controller 11.

According to the second embodiment of the present invention, the trigger controllers 6 and 7 may be formed of an optical switch having a light emitting part 6 which emits an optical signal, and a light receiving part 7 which provides the trigger signal to the semiconductor switch 13 if the light receiving part receives an optical signal from the light emitting part 6 when the first switch 4 is closed, and stops providing the trigger signal to the semiconductor switch 13 when the first switch is opened thus to cut the optical signal.

In addition, the second embodiment of the present invention is similar to the first embodiment of the present invention in that the trigger controller 6 and 7 can be configured as a micro switch to replace the optical switch. The micro switch is disposed on the way of moving of the first switch 4 to opened position so as to be interlocked with the position of the first switch 4, the micro switch provides the trigger signal to the semiconductor switch 13 when the first switch 4 is closed and stops providing the trigger signal to the semiconductor switch 13 when the first switch 4 is opened.

In the meantime, according to the second embodiment of the present invention, the circuit breaker trip drive controller 11, as shown in FIG. 4A, may be configured as an logical OR circuit (abbreviated as OR circuit) which provides a trip drive signal to the circuit breaker 15, when either the first voltage signal or second voltage signal is input.

Further, the circuit breaker trip drive controller 11, as shown in FIG. 4B, comprises: a first comparator (COM1) which compares the first voltage signal with a predetermined first reference voltage (REF1), and outputs a corresponding output signal if the first voltage signal is larger than the first reference voltage (REF1); a second comparator (COM2) which compares the second voltage signal with a predetermined second reference voltage (REF2), and outputs a corresponding output signal if the second voltage signal is larger than the second reference voltage (REF2); and an OR circuit which is connected to the output of the first and second comparators (COM1, COM2), and outputs a trip drive signal to the circuit breaker 15 if the signal is input to the OR circuit from at least one of the first and second comparators (COM1, COM2).

In FIG. 3, a reference numeral 3 indicates a line of magnetic force that is applied to the first switch 4 when the first reactor 2 is magnetized.

The first switch 4 comprises a stationary contact (not designated by reference numeral) that is connected in series to the power line between the superconductor 1 and the circuit breaker 15, and the movable contact 5 which can switch between a position in contact with the stationary contact to allow the current to flow on the power line and a position separated from the stationary contact by a magnetic force from the first reactor 2 to break the power line. A reference numeral 5a, is a component which sends a displacement state of the opening of the first switch 4 to the trigger controller 6a that is included in the movable contact 5.

A reference numeral 12 indicates a signal path for the trip drive signal to be sent from the circuit breaker trip drive controller 11 to the circuit breaker 15.

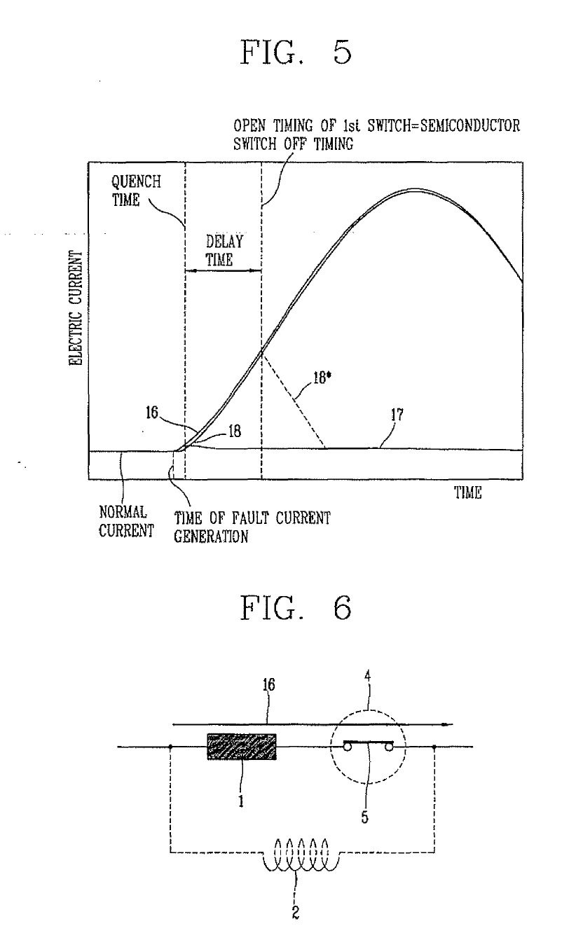

On the other hand, operation of the complex superconducting fault current limiter of the present invention having the above configuration will be described with reference to FIGS. 5 to 8 hereafter.

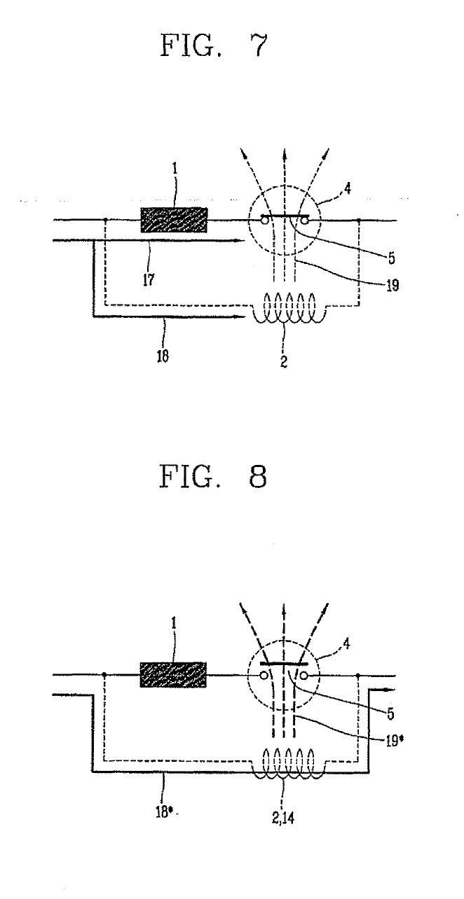

FIG. 5 is a wave form illustrating changes of the current flowing through the superconducting fault current limiter of the present invention when a fault current occurs. FIGS. 6 to 8 are explanatory views illustrating the operation of the complex superconducting fault current limiter of the present invention. FIG. 6 is an explanatory view illustrating the operation when a normal current flows through the complex superconducting fault current limiter of the present invention. FIG. 7 is an explanatory view illustrating the operation during the initial rise of a fault current flowing through the complex superconducting fault current limiter of the present invention. FIG. 8 is an explanatory view illustrating an operation completed state when a fault current flows through a branch power line of the complex superconducting fault current limiter of the present invention.

First, the operation of the complex superconducting fault current limiter of the present invention when a normal current flows on the power line will be described with reference to FIGS. 5 and 6 hereafter.

Like the wave of a normal current of FIG. 5, when a current 16 flowing on the electric power system, that is, on the power line is a normal current, the current 16 is smaller than a threshold current which causes the superconductor 1 to quench, thus, electric resistance of the superconductor 1 is “0” (zero).

The first reactor 2 has a predetermined impedance that is larger than “0” but smaller than the impedance of the superconductor 1 when a large current flows on the power line, for example, tens of mΩ (mille ohm); therefore, the current 16 does not flow into the first reactor 2, but flows into the superconductor 1 without electric resistance.

Therefore, the current 16 flows through the superconductor 1 without loss and passes through the first switch 4 thus to flow to the circuit breaker 15 of FIGS. 2 and 3.

On the other hand, hereinafter, description will be given with reference to FIG. 7 illustrating the operation during the initial rise of a fault current flowing on the complex superconducting fault current limiter of the present invention and FIG. 5 that is a wave form.

In FIG. 5, at the time of initial rise of a fault current, if accidents such as short power line or grounding occurs on the power line, the current 16 significantly rises thus to become a large current. If the complex superconducting fault current limiter of the present invention is not provided, the current 16 flowing on the power line has a sharply rising wave like the current 16 after the time of fault current generation of FIG. 5. At the initial rise of the fault current, the current 16 is divided into a current 17 flowing through the superconductor 1 and a branch current 18 flowing through the first reactor 2, as shown in FIG. 7. at this moment, when a short power line occurs, the superconductor 1 quenches within hundreds of μsec (micro second), and resistance of the superconductor sharply increases from zero to several to tens of ohm thus to be changed into a resistor. Therefore, most of the fault currents are branched to flow into the first reactor 2 having a low impedance.

At this moment, the branch current 18 flowing through the first reactor 2 has the same wave as that of FIG. 5.

Just after the superconductor 1 quenches, since the branch current 18 is small, a magnetic force that is generated by magnetizing the first reactor 2, that is, a magnetic field 19 is small, thus, an electromagnetic repulsive force is not significant, so that the movable contact 5 of the first switch 4 still remains in contact with the stationary contact, as shown in FIG. 7.

In the meantime, hereinafter, description will be given with reference to FIG. 8 illustrating an operation completed state when a fault current flows through the branch power line of the complex superconducting fault current limiter of the present invention and FIG. 5 that is a wave diagram.

If the branch current 18 gradually increases and the first reactor 2 generates a large magnetic force, that is, a large magnetic field 19* after a fault current flows into the electric power system, that is, into the power line and the superconductor 1 quenches, an eddy current on the movable contact 5 increases and an electromagnetic repulsive force between the first reactor 2 and the movable contact 5 increases; therefore, the movable contact 5 is separated from the stationary contact, as shown in FIG. 8.

At this moment, since the current flowing through the superconductor 1 and the first switch 4 has a small wave indicated by 17 of FIG. 5 due to the current limiting of the superconductor 1 and the branching into the first reactor 2, an arc does not occur when the movable contact 5 is separated from the stationary contact, and the electromagnetic repulsive force is much larger than a contact pressure (pressure sustaining the contact state) of the contacts; therefore, the movable contact 5 is completely separated from the stationary contact within a very short time, for example, the delay time illustrated in FIG. 5.

After a high speed switch, that is, the first switch 4 is opened, all of the fault currents exclusively flow into a branch path that is formed by the first reactor 2 and the second reactor 14, which is shown by a branch current 18* in FIG. 8, the branch path is connected in parallel to the power line.

In this case, to deal with voltages applied to both ends of the superconductor 1 is very important, until the first switch 4 is completely opened. According to the conventional art, in order to respond to the rise of voltages at both ends of the superconductor corresponding to the rise of resistance of the superconductor, a plurality of superconductors should be connected in series to each other, and the complex superconducting fault current limiter according to the present invention can reduce the voltage as follows.

In other words, in the complex superconducting fault current limiter according to the present invention, since the first reactor 2 has a very small impedance in the range of several to tens of mΩ, a total impedance that is obtained by adding the impedance that is generated at the time of quenching of the superconductor 1 is also very small; therefore, a high voltage is not applied to both ends of the superconductor 1. This may be expressed by the flowing equation.

V=If×Zt (1)

In Equation (1), “V” indicates the voltage that is applied to both ends of the superconductor, “If” indicates a size of a fault current, and “Zt” indicates a total impedance of the impedance of the first reactor 2 and the impedance that is generated when the superconductor 1 quenches. For example, when a fault current of 30 KA (kilo ampere) and a total impedance of 20 mΩ (mille ohm) are substituted for the equation's variables, the voltage that is applied to both ends of the superconductor is no more than 600 Volt. Such voltage is very small, as compared to a normal voltage, that is, a system voltage of a high-voltage electric power system, the system voltage is in the range of several kilo volts to hundreds kilo volts.

In addition, in the complex superconducting fault current limiter of the present invention, the superconductor 1 does not limit a large current of a short cut current. In the complex superconducting fault current limiter of the present invention, the superconductor 1 serves in branching most fault currents into the first reactor 2.

In the meantime, if the movable contact 5 of the first switch 4 is completely separated from the stationary contact, the trigger controller 6a stops sending a trigger signal to the semiconductor switch 13 and the semiconductor switch 13 is accordingly turned off. Therefore, all fault currents flow through the first reactor 2 and thus to flow into the second reactor 14 that is connected in parallel to the turned-off semiconductor switch 13. Since the second reactor 14 has a high impedance, for example, several Ω (ohm), the fault current is limited by the second reactor 14 and thus decreased as shown by a wave (18*) of FIG. 5.

In addition, after the movable contact 5 of the first switch 4 is completely separated from the stationary contact, the second reactor 14 having a high impedance also bears a high voltage due to the fault current. As for the bearing of the second reactor 14 with a high voltage, since the circuit breaker 15 is tripped instantaneously within 100 msec (mille second) by a trip drive signal from the circuit breaker trip drive controller 11, the second reactor 14 is not damaged within such an instantaneous time.

The semiconductor switch 13 allows only a fault current that is shorter than 1 ms (1 milli second) until the first switch 4 is opened, and is turned off before the fault current reaches a peak value; therefore, the switch is prevented from being damaged and is not required to have a large bearable force against a large current.

Since the second reactor 14 needs an inductance in the range of several to tens of mH (mille Henry) so as to have a high impedance in the range of several ohm, the number of winding of a coil increases. However, the second reactor does not operate when a normal current flows on the power line, and bears only a fault current within 100 msec (mille second), accordingly, the coil does not need to have a large thickness, which prevents the size of the second reactor 14 and the superconducting fault current limiter from increasing.

In addition, if either the second voltage signal indicating a rising voltage of the superconductor 1 due to the fault current flowing on the power line or the first voltage signal from the current transformer, or both of them are input, the circuit breaker trip drive controller 11 provides a trip drive signal to the circuit breaker 15, and thus the circuit breaker 15 that is connected to the trailing end of the branch path is tripped thus to break the power line. At this moment, if a fault current flows on the power line, the superconductor 1 quenches within hundreds of μsec (micro second) and generates an arbitrary resistance and voltage. therefore, the first voltage signal or/and the second voltage signal help shorten the time to detect a fault current, such that the time that is required for the circuit breaker 15 with the first and second voltage signal to break the power line becomes smaller than the time for the circuit breaker 15 only to detect a fault current.

As described above, in the complex superconducting fault current limiter according to the present invention, among the branch path connected in parallel to the superconductor, a second reactor with a high impedance bears a high voltage, so that a high voltage is not generated at both ends of the superconductor, and the branch path also bears and limits a large current of the fault current and the superconductor only bears a rated current when a normal current flows on the power line, which allows the superconducting fault current limiter to use a minimum number of superconductors.

In addition, the complex superconducting fault current limiter according to the present invention makes the superconductor in a minimum number. Therefore, it is possible to prevent problems such as malfunction and poor reliability resulting from the requirement that a large number of superconductors should simultaneously quench.

In addition, the complex superconducting fault current limiter according to the present invention detects changes of voltage of the superconductor which quenches within hundreds of μsec (micro second) so as to use the detected change in tripping of the circuit breaker. Therefore, it is possible to shorten the time to break the power line against a fault current, as compared to the time to detect a fault current by the circuit breaker only.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A complex superconducting fault current limiter comprising:
a superconductor which is connected in series to a power line;
a first switch which is connected in series to the superconductor, is closed to allow the current to flow on the power line when a normal current flows on the power line, and opened, when a large current flows on the power line, to break the power line, the first switch being opened by a magnetic force;
a first reactor which has a first impedance that is smaller than an impedance of the superconductor when a larger current flows on the power line, is connected in parallel to the superconductor, and serves as a branch path for the current flowing through the superconductor and the first switch when a larger current flows on the power line, the first reactor being magnetized by the current flowing through the branch path thus to switch the first switch to be opened;
a second reactor which is connected in series to the branch path formed by the first reactor, and has a second impedance that is larger than the first impedance of the first reactor so as to limit the large current;
a semiconductor switch which is connected in parallel to the second reactor and capable of turning on by a trigger signal; and
a trigger controller which stops sending a trigger signal to the semiconductor switch in response to the opening of the first switch.

2. The complex superconducting fault current limiter of claim 1, further comprising;
a circuit breaker which breaks the power line when a large current flows on the power line, the circuit breaker being connected to the power line behind the superconductor, the first switch and the branch path;
a current transformer which is connected to the branch path so as to detect the current flowing through the branch path, and outputs a first voltage signal corresponding to the detected current; and
a circuit breaker trip drive controller which comprises a first input that is connected to the superconductor and to which a second voltage signal corresponding to the voltage of the superconductor is input, and a second input to which a first voltage signal from the current transformer is input, and provides a trip drive signal to the circuit breaker when either the first voltage signal or the second voltage signal is input.

3. The complex superconducting fault current limiter of claim 1, wherein the trigger controller comprises an optical switch which has a light emitting part that emits an optical signal, and a light receiving part that provides the trigger signal to the semiconductor switch if the light receiving part receives the optical signal from the light emitting part when the first switch is closed, and which stops providing the trigger signal to the semiconductor switch when the first switch is opened thereby cutting the optical signal.

4. The complex superconducting fault current limiter of claim 1, wherein the trigger controller comprises a micro switch that is disposed on the way of opening position moving of the first switch so as to be interlocked to the position of the first switch, provides the trigger signal to the semiconductor switch when the first switch is closed, and when the first switch is opened, stops sending the trigger signal to the semiconductor switch.

5. The complex superconducting fault current limiter of claim 2, wherein the semiconductor switch is formed of any one of a Thyristor, a TRIAC, an IGBT (Insulated Gate Bipolar Transistor), a GTO Thyristor (Gate Turn-off Thyristor), an SSR (Solid State Relay), an FET (Field Effect Transistor), and a Transistor.

6. The complex superconducting fault current limiter of claim 2, wherein the circuit breaker trip drive controller is formed of an OR circuit which provides a trip drive signal to the circuit breaker, when either the first voltage signal or second voltage signal is input.

7. The complex superconducting fault current limiter of claim 2, wherein the circuit breaker trip drive controller comprises:
a first comparator which compares the first voltage signal with a predetermined first reference voltage, and outputs a corresponding signal if the first voltage signal is larger than the first reference voltage;
a second comparator which compares the second voltage signal with a predetermined second reference voltage, and outputs a corresponding signal if the second voltage signal is larger than the second reference voltage; and
an OR circuit which is connected to the outputs of the first and second comparators, and outputs a trip drive signal to the circuit breaker if the signal is input to the OR circuit from at least one of the first and second comparators.

8. The complex superconducting fault current limiter of claim 1, wherein the first switch is a normal close contact switch.

9. The complex superconducting fault current limiter of claim 1, wherein the first switch comprises a stationary contact which is connected in series to the power line between the superconductor and the circuit breaker, and the movable contact which can switch between a position in contact with the stationary contact to allow the current to flow on the power line and a position separated from the stationary contact by a magnetic force from the first reactor to break the power line.

10. A complex superconducting fault current limiter comprising:
a superconductor which is connected in series to the power line;
a first switch which is connected in series to the superconductor, is closed to allow the current to flow on the power line when a normal current flows on the power line, and opened, when a large current flows on the power line, to break the power line, the first switch being opened by a magnetic force;
a first reactor which has a first impedance that is smaller than an impedance of the superconductor when a larger current flows on the power line, is connected in parallel to the superconductor, and serves as a branch path for the current flowing through the superconductor and the first switch when a larger current flows on the power line, the first reactor being magnetized by the current flowing through the branch path thus to switch the first switch to be opened;
a second reactor which is connected in series to the branch path formed by the first reactor, and has a second impedance that is larger than the first impedance of the first reactor so as to limit the large current;
a semiconductor switch which is connected in parallel to the second reactor and capable of turning on by a trigger signal;
a trigger controller which stops sending a trigger signal to the semiconductor switch in response to the opening of the first switch;
a circuit breaker which breaks the power line when a large current flows on the power line, the circuit breaker being connected to the power line behind the superconductor, the first switch and the branch path;
a current transformer which is connected to the branch path so as to detect the current flowing through the branch path, and outputs a first voltage signal corresponding to the detected current; and
a circuit breaker trip drive controller which comprises a first input that is connected to the superconductor and to which a second voltage signal corresponding to the voltage of the superconductor is input, and a second input to which a first voltage signal from the current transformer is input, and provides a trip drive signal to the circuit breaker when either the first voltage signal or the second voltage signal is input.
